(19) United States
(12) Patent Application Publication
(10) Pub. No.: US 2023/0387502 A1
(43) Pub. Date: Nov. 30, 2023

(54) COMBINED THERMAL MANAGEMENT AND FIRE MITIGATION FOR LARGE SCALE BATTERY PACKAGES

(71) Applicant: Kidde Technologies, Inc., Wilson, NC (US)

(72) Inventors: Paul Papas, West Hartford, CT (US); Robert M. Darling, South Windsor, CT (US); Malcolm P. MacDonald, Bloomfield, CT (US)

(21) Appl. No.: 17/828,267

(22) Filed: May 31, 2022

(51) Int. Cl. H01M 10/6556; H01M 10/613; H01M 10/625; H01M 10/6569; H01M 10/653

(52) U.S. Cl. CPC H01M 10/6556; H01M 10/613; H01M 10/625; H01M 10/6569; H01M 10/653; H01M 2220/20

(57) ABSTRACT

A battery system of an aircraft includes one or more battery packages. Each battery package includes a plurality of battery cells. A thermal management system is fluidly connected to the one or more battery packages. The cooling system has a flow of coolant flowing therethrough. Thermal energy is dissipated from the one or more battery packages via a phase change of the flow of coolant. A method of managing thermal energy of a battery package includes conducting thermal energy from a plurality of battery cells via a conductive inter-cell separator located between adjacent battery cells, and transferring the thermal energy from the inter-cell separator to a flow of coolant in thermal communication with the conductive inter-cell separator, thereby causing a phase change in the flow of coolant resulting in cooling of the plurality of battery cells. The thermal energy is then dissipated from the flow of coolant.

### BACKGROUND

Exemplary embodiments pertain to the art of battery packages such as metal-ion battery packages, and in particular to thermal management of metal-ion battery packages. Large metal-ion battery packages, such as lithium-ion battery packages are seeing increased usage in aircraft applications. With increased use of such battery packages for aircraft, packaging designs are required for heat dissipation during normal operation as well as mitigation and fire containment during thermal runaway failures of the battery. Current thermal management, such as air cooling of the battery packages, is inadequate to address the reliability and fire safety requirements of the aviation industry. Once metal-ion battery fires form, mitigation using externally installed fire protection systems becomes prohibitively difficult.

### BRIEF DESCRIPTION

In one embodiment, a battery system of an aircraft includes one or more battery packages. Each battery package includes a plurality of battery cells. A thermal management system is fluidly connected to the one or more battery packages. The cooling system has a flow of coolant flowing therethrough. Thermal energy is dissipated from the one or more battery packages via a phase change of the flow of coolant.

Additionally or alternatively, in this or other embodiments the thermal management system includes a thermally conductive inter-cell separator located between adjacent battery cells of the plurality of battery cells. Two or more coolant flow passages are operably connected to the inter-cell separator. The inter-cell separator is configured to conduct thermal energy from the plurality of battery cells and transfer the thermal energy into the flow of coolant flowing through the two or more coolant passages.

Additionally or alternatively, in this or other embodiments the inter-cell separator is formed from one of metal material or thermally conductive material.

Additionally or alternatively, in this or other embodiments the inter-cell separator is formed from a polymer with a metal coating such that the polymer inhibits thermal energy transfer between adjacent battery cells and the metal coating provides for transfer of thermal energy toward the two or more coolant passages.

Additionally or alternatively, in this or other embodiments the two or more coolant flow passages are each located at opposing sides of the battery package or cells.

Additionally or alternatively, in this or other embodiments one or more suppressant nozzles are operably connected to the two or more coolant flow passages or reservoir tank.

Additionally or alternatively, in this or other embodiments the one or more suppressant nozzles are configured to selectably emit the flow of coolant into the battery cells.

Additionally or alternatively, in this or other embodiments a condenser heat exchanger is fluidly connected to the flow of coolant to condense the flow of coolant to saturated liquid.

Additionally or alternatively, in this or other embodiments the condenser heat exchanger is a coolant to air heat exchanger.

Additionally or alternatively, in this or other embodiments the flow of coolant changes phase from liquid to vapor phase in a range of 10 degrees to 45 degrees Celsius.

In another embodiment, a method of managing thermal energy of a battery package of a vehicle includes conducting thermal energy from a plurality of battery cells via a conductive inter-cell separator located between adjacent battery cells of the plurality of battery cells, and transferring the thermal energy from the inter-cell separator to a flow of coolant in thermal communication with the conductive inter-cell separator, thereby causing a phase change in the flow of coolant resulting in cooling of the plurality of battery cells. The thermal energy is then dissipated from the flow of coolant.

Additionally or alternatively, in this or other embodiments the thermal energy is dissipated from the flow of coolant via a condenser heat exchanger.

Additionally or alternatively, in this or other embodiments the condenser heat exchanger is a coolant to air heat exchanger.

Additionally or alternatively, in this or other embodiments the flow of coolant changes phase from liquid to vapor in a range of 10 to 45 degrees Celsius.

Additionally or alternatively, in this or other embodiments the flow of coolant is flowed through one or more coolant passages in thermal communication with the inter-cell separator.

Additionally or alternatively, in this or other embodiments the flow of coolant is flowed through the one or more coolant passages via a pump.

Additionally or alternatively, in this or other embodiments the inter-cell separator is formed from one of a metal material or a thermally conductive material.

Additionally or alternatively, in this or other embodiments the inter-cell separator is formed from a polymer with a metal coating such that the polymer inhibits thermal energy transfer between adjacent battery cells and the metal coating provides for transfer of thermal energy toward the two or more coolant passages.

Additionally or alternatively, in this or other embodiments one or more suppressant nozzles are operably connected to the one or more coolant flow passages.

Additionally or alternatively, in this or other embodiments the one or more suppressant nozzles are configured to selectably emit the flow of coolant into the battery package region.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a battery system of a vehicle;

FIG. 2 is a schematic illustration of an embodiment of a cooling system of a battery package;

FIG. 3 is a schematic illustration of another embodiment of a cooling system of a battery package; and

FIG. 4 is a schematic illustration of yet another embodiment of a cooling system of a battery package.

### DETAILED DESCRIPTION

A detailed description of one or more embodiments of the disclosed apparatus and method are presented herein by way of exemplification and not limitation with reference to the Figures.

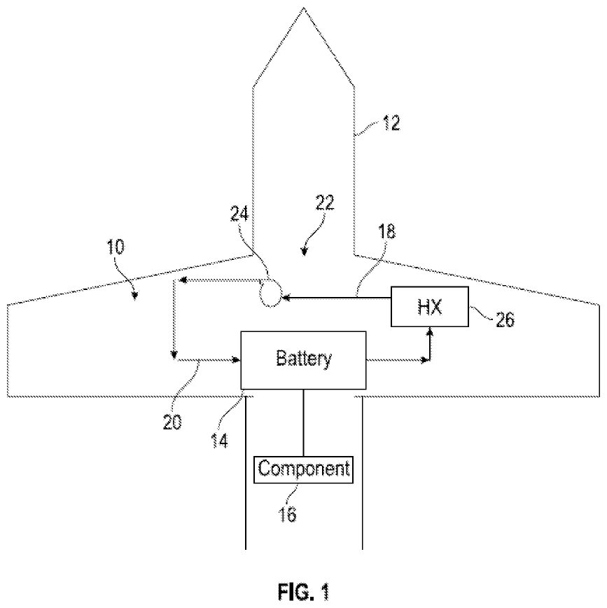

Referring now to FIG. 1, disclosed is an embodiment of a battery system 10 of, for example, an aircraft shown schematically at 12. While the embodiments are described herein in the context of the aircraft 12, one skilled in the art will readily appreciate that the battery system 10 may be utilized in other applications, such as ships, trucks, buses, trains or the like.

The battery system 10 includes one or more battery packages 14 operably connected to one or more aircraft components 16 to provide electrical power to the one or more aircraft components 16. Since, during operation, the one or more battery packages 14 generate heat, a thermal management system 18 is provided to cool the one or more battery packages 14. The cooling is provided via a two-phase flow of coolant 20 circulated through the one or more battery packages 14. The flow of coolant 20 is flowed through a coolant circuit 22 by a pump 24, which regulates pressure and directs the flow of coolant 20 into the one or more battery packages 14 as a saturated liquid. At the one or more battery packages 14, at least a portion of the flow of coolant 20 is vaporized by the transfer of thermal energy from the one or more battery packages 14 resulting in an increase in the overall vapor quality, which defines the proportions of the liquid and vapor phases in the mixture. The flow of coolant 20 exits the one or more battery packages 14 and proceeds through a condensing heat exchanger 26 where the thermal energy is dissipated to ambient and the flow of coolant 20 is condensed to a saturated liquid phase. In some embodiments, the condensing heat exchanger 26 is a two-phase coolant to air heat exchanger such as illustrated, while in other embodiments the condensing heat exchanger 26 is a two-phase coolant to liquid heat exchanger, in which the thermal energy is transferred to a secondary coolant flow. The liquid may be, for example, aircraft fuel or grey water from the aircraft cabin. One skilled in the art will readily appreciate that these are merely examples, and that other liquids may be utilized to exchange thermal energy with the flow of coolant 20.

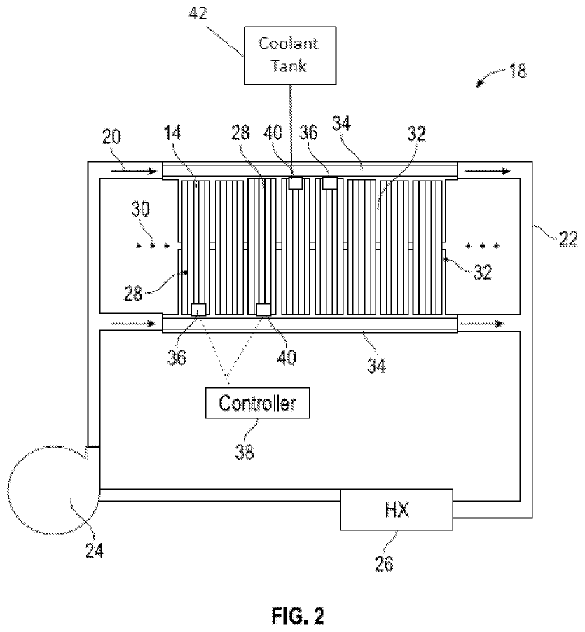

An embodiment of an exemplary battery package 14 and thermal management system 18 is illustrated in FIG. 2. The battery package 14 includes a plurality of battery cells 28 in an arrangement which is, in some embodiment, along a battery axis 30. While a linear arrangement of the battery cells 28 is illustrated in FIG. 2, one skilled in the art will readily appreciate that other arrangements of battery cells 28 may be utilized. Conductive inter-cell separators 32 are disposed between adjacent battery cells 28 of the plurality of battery cells 28. The inter-cell separators 32 are formed from a material with a high thermal conductivity such as, for example, an aluminum, brass or copper material or a polymer-based material or a metal coated polymer having a high thermal conductivity. The inter-cell separator 32 may formed from a polymer with a metal coating such that the polymer inhibits thermal energy transfer between adjacent battery cells 28 and the metal coating provides for transfer of thermal energy toward the coolant passages 34. The inter-cell separators 32 are connected to coolant passages 34, which in some embodiments are located at lateral sides of the battery cells 28. The coolant passages 34 convey the flow of coolant 20 through the battery package 14 from the pump 22 toward the condensing heat exchanger 26. As shown in FIG. 2, in some embodiments the flow of coolant 20 in each of the coolant passages 34 is in the same direction, while in other embodiments the flow of coolant 20 in the coolant passages 34 is in opposing directions.

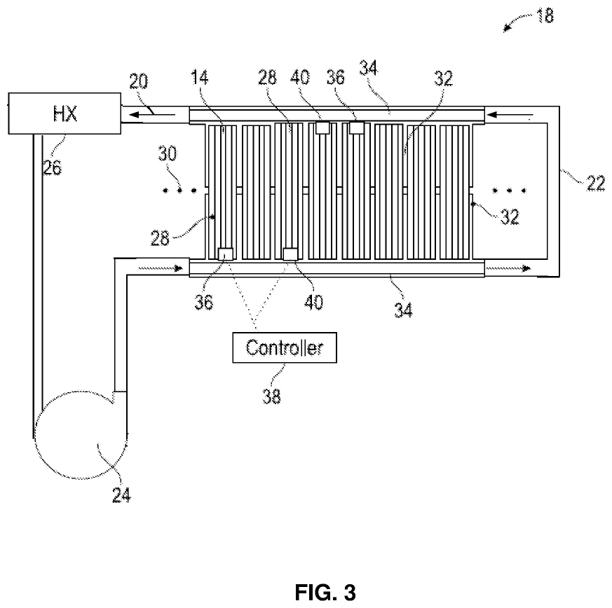

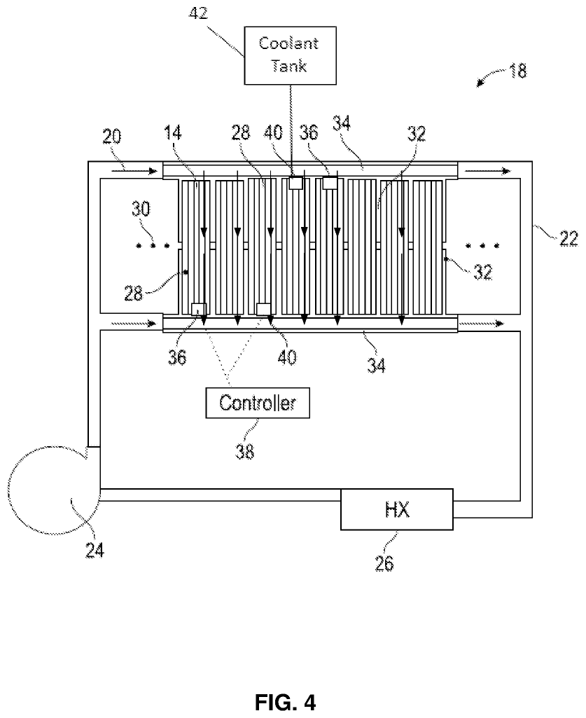

Referring to FIG. 3, in other embodiments the coolant passages 34 are arranged in series to increase heat transfer coefficients, in the event heat from a single pass is not sufficient to heat the flow of coolant 20 into a two-phase regime. In other embodiments, as illustrated in FIG. 4, the inter-cell separators 32 are configured such that the flow of coolant 20 is directed through the inter-cell separators 32 for additional thermal energy transfer.

Referring again to FIG. 2, the thermal management system 18 may also include one or more suppression nozzles 40 along the coolant passages 34 and one or more thermal sensors 36 disposed in the battery package 14. The nozzles 40, the pump 24 and the one or more thermal sensors 36 are connected to a cooling system controller 38. In response to temperatures of the battery cells 28 detected by the one or more thermal sensors 36, the controller 38 may command the pump 24 to deliver an increased mass flow of the flow of coolant 20 through the coolant passages 34. Additionally, if a runaway temperature of the battery cells 28 is detected, the controller 28 may command opening of the suppression nozzles 40 to emit or spray flow of coolant 20 or suppressant onto the battery cells 28 to stop the runaway temperature condition of the battery cells 28. In some embodiments, a coolant or suppressant reservoir 42 is connected to the suppression nozzles 40, and additional coolant or suppressant may be directed to the suppression nozzles 40 as needed to stop the runaway condition.

In some embodiments, the flow of coolant 20 is configured to have a saturation temperature above or below typical room temperature, in some embodiments in a range of 10 to 45 degrees Celsius. Examples of the flow of coolant 20 include low-pressure water, and low pressure low global warming potential (GWP) refrigerants such as R1233zd(E). Other refrigerants, such as R125, which are also fire suppressants, may be utilized. One skilled in the art will appreciate that these materials are merely exemplary and that other suitable coolants may be used. The phase change of the coolant 20 from liquid to vapor may occur at, for example, 40 degrees Celsius. Thus, in normal operating conditions of the battery package 14, the flow of coolant 20 may remain constant, and at a lower heat generation from operation of the battery package would produce relatively less vapor phase, while at a higher heat generation, as would occur during thermal runaway, a greater portion of the of the flow of coolant 20 is converted to the vapor phase (i.e., would produce a relatively higher vapor quality).

While in the description above, the thermal management system 18 is configured to cool the battery package 14, the thermal management system 18 may be operated as a heat pump to add thermal energy to the battery package 14 for operation in harsh environments where the ambient temperature may be sub-freezing.

The use of two-phase flow of coolant 20 allows for effective and efficient cooling of the battery packages 14, and may be combined with a suppression apparatus to prevent or mitigate thermal runaway of the battery packages 14.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A battery system of an aircraft comprising:
one or more battery packages, each battery package including a plurality of battery cells;
a thermal management system fluidly connected to the one or more battery packages, the cooling system having a flow of coolant flowing therethrough;
wherein thermal energy is dissipated from the one or more battery packages via a phase change of the flow of coolant; and
a condenser heat exchanger fluidly connected to the flow of coolant to condense the flow of coolant to saturated liquid.

2. The battery system of claim 1, wherein the thermal management system includes:
a thermally conductive inter-cell separator disposed between adjacent battery cells of the plurality of battery cells; and
two or more coolant flow passages operably connected to the inter-cell separator;
wherein the inter-cell separator is configured to conduct thermal energy from the plurality of battery cells and transfer the thermal energy into the flow of coolant flowing through the two or more coolant passages.

3. The battery system of claim 2, wherein the inter-cell separator is formed from a thermally conductive material.

4. The battery system of claim 2, wherein the inter-cell separator is formed from a polymer with a metal coating such that the polymer inhibits thermal energy transfer between adjacent battery cells and the metal coating provides for transfer of thermal energy toward the two or more coolant passages.

5. The battery system of claim 2, wherein the two or more coolant flow passages are each located at opposing sides of the battery package or cells.

6. The battery system of claim 1, further comprising one or more suppressant nozzles operably connected to the two or more coolant flow passages or reservoir tank.

7. The battery system of claim 6, wherein the one or more suppressant nozzles are configured to selectably emit the flow of coolant into the battery cells.

8. The battery system of claim 1, wherein the condenser heat exchanger is a coolant to air heat exchanger.

9. The battery system of claim 1, wherein the flow of coolant changes phase from liquid to vapor phase in a range of 10 degrees to 45 degrees Celsius.

10. The battery system of claim 9, wherein the flow of coolant is one of low-pressure water, low pressure low global warming potential (GWP) refrigerant, refrigerant R1233zd(E) or R125.

11. A method of managing thermal energy of a battery package of a vehicle, comprising:
conducting thermal energy from a plurality of battery cells via a conductive inter-cell separator disposed between adjacent battery cells of the plurality of battery cells;
transferring the thermal energy from the inter-cell separator to a flow of coolant in thermal communication with the conductive inter-cell separator, thereby causing a phase change in the flow of coolant resulting in cooling of the plurality of battery cells; and
dissipating the thermal energy from the flow of coolant.

12. The method of claim 11, further comprising dissipating the thermal energy from the flow of coolant via a condenser heat exchanger.

13. The method of claim 12, wherein the condenser heat exchanger is a coolant to air heat exchanger.

14. The method of claim 11, wherein the flow of coolant changes phase from liquid to vapor in a range of 10 to 45 degrees Celsius.

15. The method of claim 11, wherein the flow of coolant is flowed through one or more coolant passages in thermal communication with the inter-cell separator.

16. The method of claim 15, wherein the flow of coolant is flowed through the one or more coolant passages via a pump.

17. The method of claim 11, wherein the inter-cell separator is formed from one of a metal material or a thermally conductive material.

18. The method of claim 11, wherein the inter-cell separator is formed from a polymer with a metal coating such that the polymer inhibits thermal energy transfer between adjacent battery cells and the metal coating provides for transfer of thermal energy toward the two or more coolant passages.

19. The method of claim 11, further comprising one or more suppressant nozzles operably connected to the one or more coolant flow passages.

20. The method of claim 19, wherein the one or more suppressant nozzles are configured to selectably emit the flow of coolant into the battery package region.
